(19) United States
(12) Patent Application Publication
(10) Pub. No.: US 2018/0158148 A1
(43) Pub. Date: Jun. 7, 2018

(54) Vehicle Service Contract Rating Method and Algorithm System

(71) Applicants: Joel San Antonio, Dallas, TX (US); Dominic Sansone, Dallas, TX (US)

(72) Inventors: Joel San Antonio, Dallas, TX (US); Dominic Sansone, Dallas, TX (US)

(21) Appl. No.: 15/870,869

(22) Filed: Jan. 13, 2018

(51) Int. Cl. G06Q 40/08; G06Q 30/00; G07C 5/00

(52) U.S. Cl. CPC G06Q 40/08; G07C 5/006; G06Q 30/01

(57) ABSTRACT

In an embodiment, a method is provided. The method includes receiving a request for a vehicle service contract. The request includes a mileage of a vehicle, a type of the vehicle, a custom requested coverage for the vehicle and a custom requested term of the vehicle service contract. The method also includes analyzing specific vehicle details from request for vehicle service contract. The method further includes calculating a custom quote for the vehicle service contract based on the mileage of the vehicle, the type of vehicle, a custom requested coverage and a custom requested term of the vehicle service contract. The method also includes providing the custom quote for vehicle service contract to a consumer. The method further includes receiving a request to complete vehicle service contract based on custom quote from consumer. The method includes issuing vehicle service contract to consumer based on custom quote and request to complete the vehicle service contract from consumer.

### BACKGROUND

### 1. Field of Invention

The present invention relates to the field of methods for pricing vehicle service contract insurance coverage through unique rating calculations and a computer algorithm system therefor.

### 2. Description of Related Art

Currently, manufacturers have provided warranties in the form of a manufacturer warranty for a period of time, or, in the case of a vehicle such as a car, various warranty periods for different components or component groups. An example for cars is a bumper-to-bumper warranty for all components of the car. Tire warranties are provided separately from the tire manufacturer, or are provided by the tire manufacturer through the car manufacturer.

Prior art extended warranties or vehicle service contracts by manufacturers or independent administrators are not customizable to the extent of our new model. Some customers are looking for more coverage, and don't mind paying for it, and some are looking for less coverage, to reduce costs, or if they know they will be modifying the vehicle to outside of the warranty terms.

In addition, manufacturer warranties are usually voided with modifications to a vehicle, but runny users want to modify their vehicle for a unique look, faster performance or more capable off-road performance with a lift kit.

Vehicle service contract plans are typically designed with the oversight of an actuary to determine the possibility of loss on the vehicle service contract, in order to maintain profitability. This is in conjunction with history of vehicle defects, to further information the likelihood of loss.

Based on the consumer's driving habits, there is a need in the art for a more flexible vehicle service contract insurance program for cars and other consumer goods.

### SUMMARY

In an embodiment, a method is provided. The method includes receiving a request for a vehicle service contract. The request includes a mileage of a vehicle, a type of the vehicle, a custom requested coverage for the vehicle and a custom requested term of the vehicle service contract. The method also includes analyzing specific vehicle details from request for vehicle service contract. The method further includes calculating a custom quote for the vehicle service contract based on the mileage of the vehicle, the type of vehicle, a custom requested coverage and a custom requested term of the vehicle service contract. The method also includes providing the custom quote for vehicle service contract to a consumer. The method further includes receiving a request to complete vehicle service contract based on custom quote from consumer. The method includes issuing vehicle service contract to consumer based on custom quote and request to complete the vehicle service contract from consumer.

Calculating a custom quote for a vehicle service contract may be based on mileage of vehicle enumerated in miles, type of vehicle, custom requested coverage, custom requested term of vehicle service contract enumerated in days, a factor for any requested powertrain coverage, a factor for any requested non-powertrain coverage, a factor adjusting for present Mile age of the vehicle enumerated in miles, a factor adjusting for present age of the vehicle enumerated in days, a factor adjusting for a vehicle class of the vehicle, a factor adjusting for a deductible amount of the vehicle service contract and a minimum premium for the vehicle service contract.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates an embodiment of a system that may be used in providing a vehicle service contract for an item.

FIG. 2 illustrates an embodiment of stem that may be used in administering requests related to a vehicle service contract.

FIG. 3 illustrates an embodiment of a system that may combine the systems of FIGS. 1 and 2.

FIG. 4 illustrates an embodiment of a process of providing a vehicle service contract.

FIG. 5 illustrates another embodiment of a process of providing a vehicle service contract.

FIG. 6 illustrates an embodiment of a process off fulfilling requests under a vehicle service contract.

FIG. 7 illustrates another embodiment of a process of fulfilling requests under a vehicle service contract.

FIG. 8 illustrates an embodiment of a system which may be used to provide a vehicle service contract.

FIG. 9 illustrates an embodiment of a process which may be used to provide a quote for a vehicle service contract.

FIG. 10 illustrates an embodiment of a computer or similar device which may be used to implement some of all of the processes described herein.

FIG. 11 illustrates an embodiment of a system or network which may be used with the device of FIG. 10.

### DETAILED DESCRIPTION

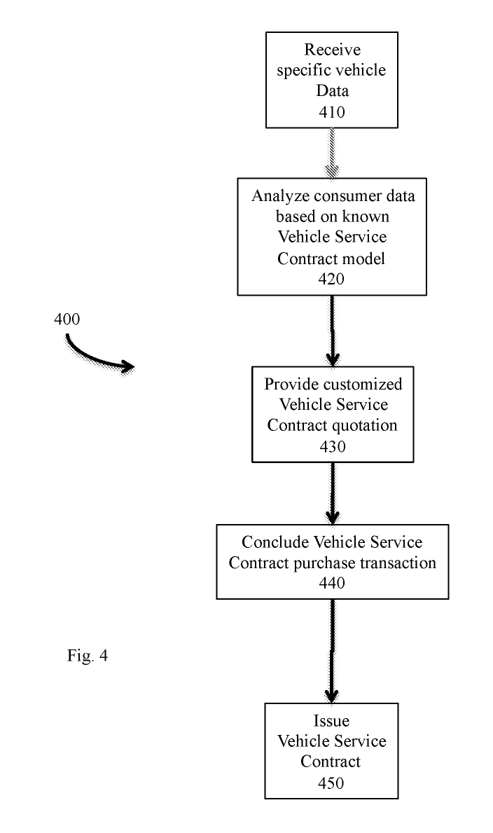

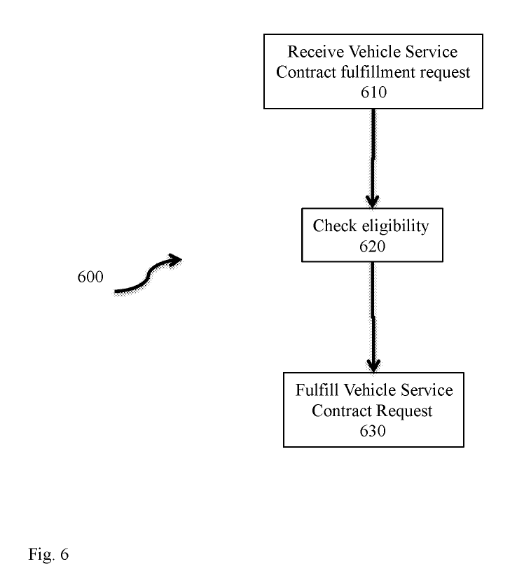

In various embodiments, a vehicle service contract coverage method and system is provided. Various embodiments of the invention and potential advantages may he understood by referring to the various figures, wherein like reference numerals refer to like elements. Other aspects of the embodiments will be apparent as available from a combination of the various embodiments, such as the processes of FIGS. 4 and 6 or 5 and 7, for example.

A vehicle service contract provides a form of insurance against problems with a vehicle. For example, a vehicle service contract may provide for routine maintenance of an automobile, or may provide for repair or replacement of a personal device such as a mobile phone, for example. Flexible aspects of the insurance for an automobile include term, expiration, mileage and deductible, for example. The terms may be customizable and may provide for commercial use, overheating repair, emissions, diagnostic, safety restraint coverage, lift kit, sensor coverage, and, in case the car breaks down, towing and roadside assistance, as well as maintenance.

A beneficial vehicle service contract program may provide access to agents, including on a full-time or 24-hour basis. The agents may track the vehicle service contract beneficiary from the phone number and immediately look up the vehicle service contract to determine the extent of the customer's coverage and to help the customer with a claim or other information. The customers may communicate with agents using user devices, such as portable devices or computers.

The model may create powertrain and non-powertrain components, which are calculated separately though in a similar manner, for example. All coverages (even powertrain only) may have both components in the calculation.

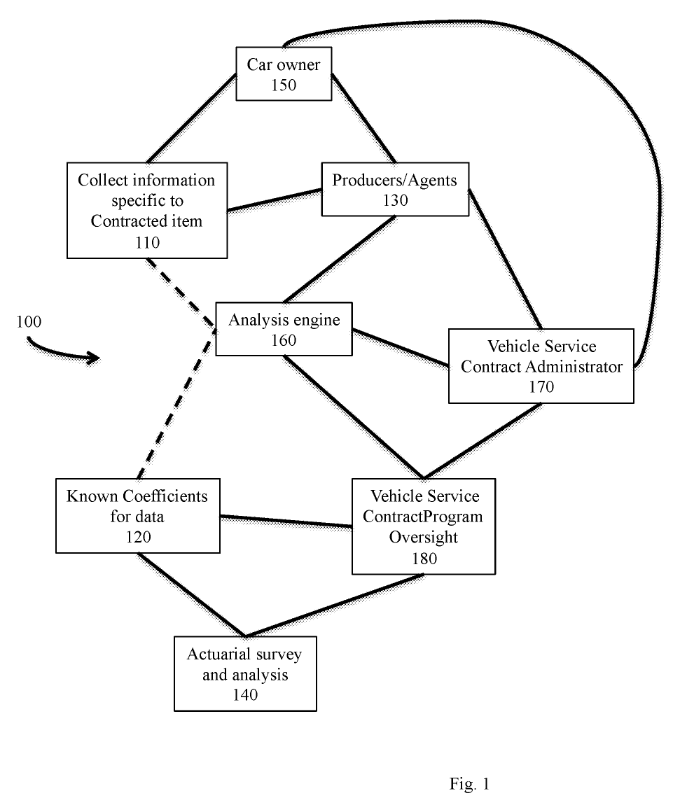

Referring to FIG. 1, an embodiment of a system that may be used in providing a vehicle service contract is illustrated. System 100 provides for gathering of information upon request for a vehicle service contract, interaction and issuing of a vehicle service contract. A user or consumer 150 may interact with a producer or agent 130 to request a vehicle service contract. A producer or agent 130 may be a cashier at a store, salesperson at a car dealership, or an agent taking requests over a phone, for example. The consumer 150 and producer 130 provide information about the specific item to be warranted to an analysis engine 160. The analysis engine 160 receives the collected information about the specific item 110 from the consumer 150, producer 130, and potentially from third party sources such as a telecommunications carrier or a motor vehicle regulatory agency, for example. Analysis engine 160 also receives coefficients for data 120 as part of a set of known aggregate data about types of vehicles. Analysis engine 160 then compares the specific item data 110 with the general data 120 to determine an appropriate vehicle service contract in terms of overall coverage, deductible, and premium. Some of a deductible, coverage details and premium may be specified as part of the specific item data 110 to indicate What a customer is willing to consider, for example.

Vehicle service contract administrator 170 then receives information from the analysis engine 160 and works with producer 130 to issue a vehicle service contract to consumer 150. This may then provide for protection and peace of mind for the consumer 150. It may also provide for a level of cost certainty for the consumer 150.

Vehicle service contract program oversight 180 also monitors the results of analysis engine 160, and provides feedback to update general data 120 and may interact with actuarial survey and analysis 140 to update general data set 120 over time, for example. Additionally vehicle service contract oversight 180 may be able to step in to change transactions with vehicle service contract administrator 170 in unusual circumstances in some embodiments. Moreover, warrant program oversight 180 and vehicle service contract administration 170 may be provided by the same entity or different entities, varying from one embodiment to another.

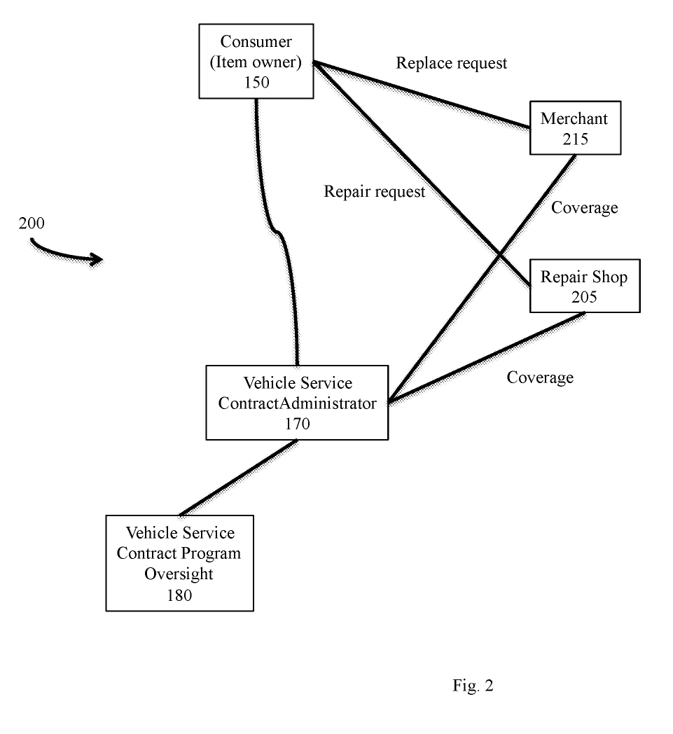

Turning to FIG. 2, a consumer 150 may take a vehicle to a merchant 215 to request replacement of a damaged item, or to a repair shop 205 to request repair in system 200.

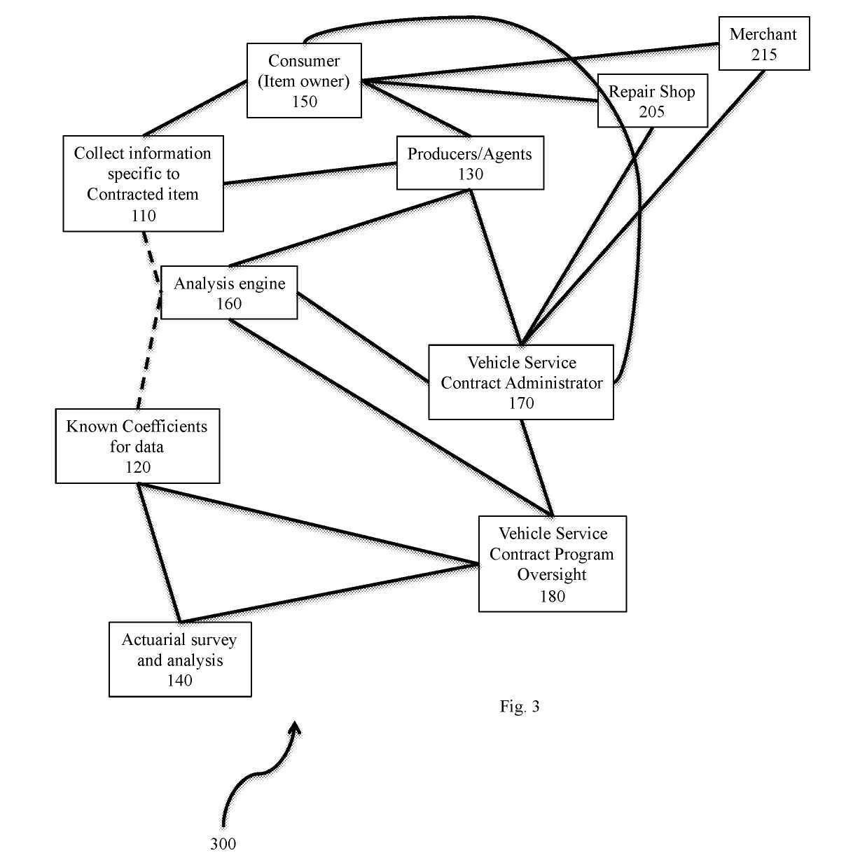

In order to invoke vehicle service contract coverage, the consumer 150, or the vendor (either merchant 215 or shop 205) may contact vehicle service contract administrator 170. Vehicle service contract administrator 170 determines whether coverage is available, such as whether a vehicle service contract exists and is in force for a specific vehicle, and provides that information to the vendor (205 or 215) and/or consumer 150. Further details may specify the type of coverage available and limits of compensation, for example. Vehicle service contract program oversight 180 may also monitor these transactions to determine if the vehicle service contract program is being used properly. [0027] FIG. 3 illustrates how the various different systems 100 and 200 may interact and combine to form an overall system 300 which may receive vehicle service contract requests, issue warranties, receive coverage requests, provide coverage, receive financing requests and provide financing, for example. Thus, system 300 may provide for receiving a request from a consumer through a process leading to replacement of a device or repair of a car, for example. Additionally, payments may be processed along the way for initial premiums, periodic installments, repair or replacement costs, and other reimbursement, for example.

Processes implemented for the systems of FIGS. 1-3 may be implemented in a variety of ways in various embodiments. FIG. 4 illustrates a process in an embodiment. Process 400 includes receiving specific consumer data with a request for a vehicle service contract, analyzing the data in comparison to general data, providing customized vehicle service contract quotation options, concluding a vehicle service contract transaction, and issuing a vehicle service contract.

At module 410, a consumer requests a vehicle service contract and provides initial data specific to the item to be warranted. At module 420, the system analyzes the specific data in comparison to general data such as wear per mile or lifetime of a device after a certain amount opine, for example. At module 430, a customized vehicle service contract quotation is provided. This may include options for amount of time, levels of coverage, and levels of deductibles, for example. At module 440, a vehicle service contract transaction is concluded, such as through payment of a premium or financing of a premium, for example. At module 450, the vehicle service contract is issued.

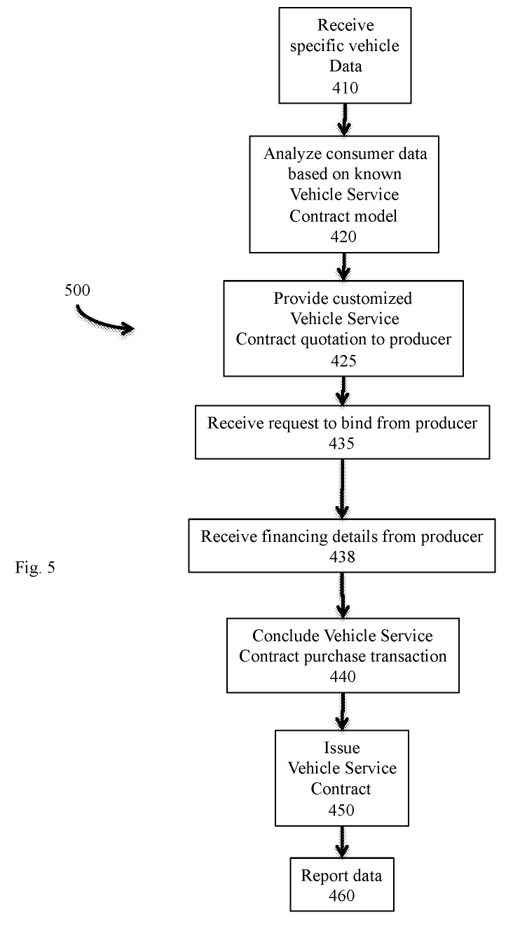

Process 500 of FIG. 5 provides a similar process to process 400, with some additional parts of the process. The customized quotation is provided to a producer acting as intermediary for a consumer at module 425, and acceptance of the (or a) quote is provided through a request to bind from the producer at module 435. The producer also provides financing details at module 438, leading to conclusion of the vehicle service contract transaction at 440. Moreover, the process concludes with reporting of data for vehicle service contract program oversight at module 460.

Process 600 of FIG. 5 provides for a simple embodiment of a process of fulfilling a request for a vehicle service contract. At module 610, a vehicle service contract request is received, such as from a merchant. At module 620, coverage is checked, and at module 630, the administrator signals that coverage is present and causes the merchant to fulfill the vehicle service contract request. This may involve replacing a defective device, repairing a device, or repairing a vehicle, for example. This may also involve administering a deductible or reimbursement rather than straight payment to a merchant, for example.

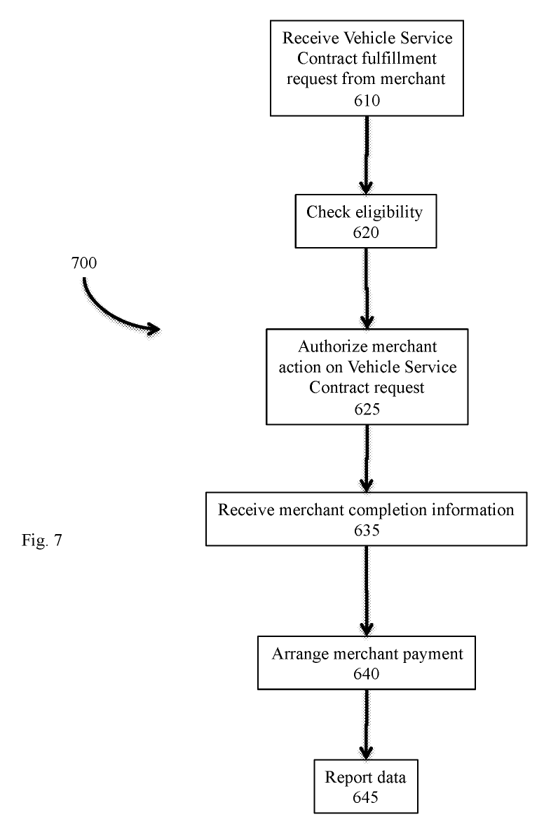

Process 700 provides a more complex embodiment in FIG. 7. After checking eligibility, merchant action is authorized at module 625, and a merchant provides a signal indicating completion of that action at module 635. At module 640, merchant payment is arranged based on satisfactory completion of fulfillment of the vehicle service contract request. Additionally, at module 645, data on the performance of the merchant, type of service and type of vehicle may be reported to the vehicle service contract administrator and vehicle service contract oversight. Types of action may include repair and part replacement for an automobile, for example.

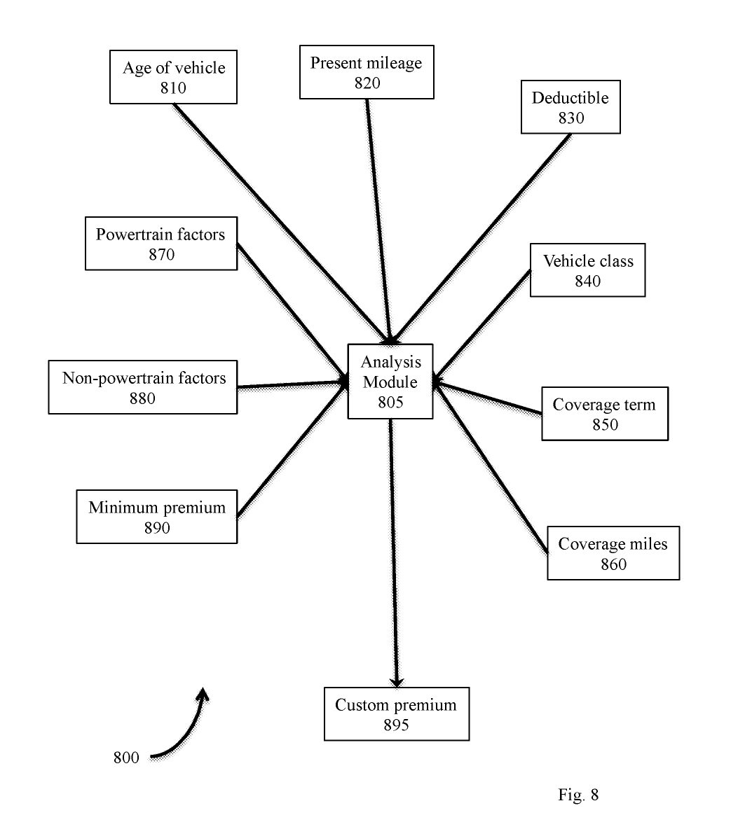

System 800 further illustrates the calculation system for the vehicle service contract. FIG. 8 illustrates an embodiment of a system which may be used to provide a vehicle service contract. System 800 analyzes various input sources to determine an appropriate premium for a vehicle service contract for a vehicle. Analysis module 805 receives inputs from a consumer (potentially through a third party) along with inputs from historical databases, and then determines a premium based on those inputs.

Consumer inputs may include age of vehicle 810, present mileage 820, requested deductible 830, requested coverage term 850 and requested coverage mileage 860, for example. Other inputs ma include vehicle class information 840, powertrain factors for the vehicle 870 and non-powertrain factors for the vehicle 880. Moreover, a minimum premium 890 may be specified to indicate a floor for a price for a vehicle service contract. Analysis module 805 then calculates a custom premium based on the various inputs, providing for a premium specific to the vehicle, current mileage, age, and requested parameters such as length of the vehicle service contract and mileage covered by the vehicle service contract.

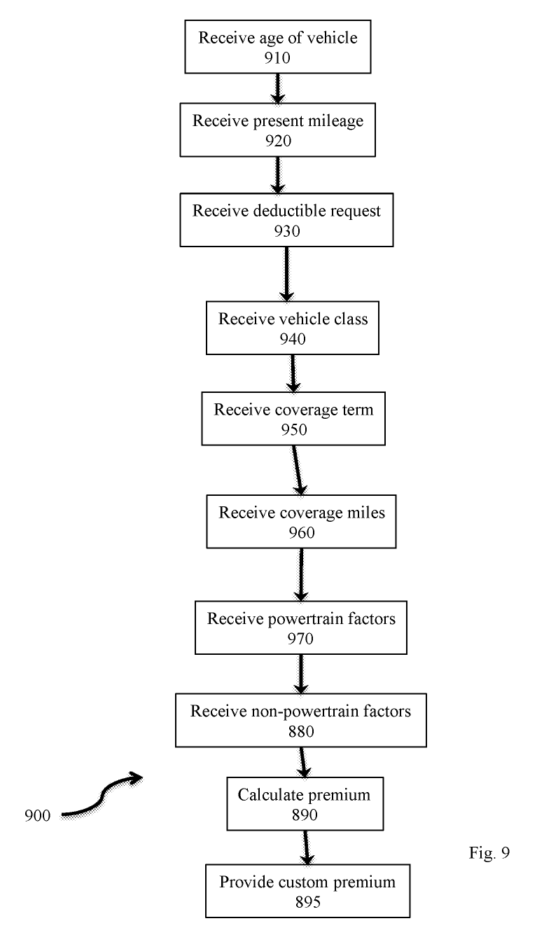

FIG. 9 illustrates an embodiment of a process which may be used to provide a quote for a vehicle service contract. Process 900 may implement a process of calculating a premium similar to that executed by system 800, for example. Process 900 is provided as a series of modules, which may be implemented as software, executed by hardware, or a combination of the two, and may be implemented in serial, parallel or some combination of serial and parallel processing.

Process 900 initiates with receipt of a request for a vehicle service contract (not shown). At module 910, an age of a vehicle is provided, and at module 920, current mileage of a vehicle is provided. A deductible is requested by a consumer at module 930, which may be a custom deductible that is factored into calculations. Similarly, the current mileage and age of the vehicle are calculated on a per mile basis or a per month basis to determine a starting point for a premium.

At module 940, a vehicle class is provided, determining the type of vehicle to be covered. This further affects the premium based on the factors of module 910,920 and 930. At module 950 and 960 a coverage term (in time) and mileage are received from a consumer, determining what the consumer wishes to cover for the vehicle—how many miles and over how many months or years, for example. The coverage terms in time and mileage are then converted into factors which scale the expected cost of a vehicle service

At module 970, powertrain factors are received, such as historical issues with the vehicle class of module 940 or known features and options of the vehicle class of 940. The premium is further modified based on higher- or lower-cost aspects of the powertrain factors of module 970. The powertrain factors are similar calculated into the premium, either by adding additional premium cost or multiplying the premium depending on whether these factors add to the cost or scale the cost over time. For example, expected problems at a threshold mileage may add to a cost if the vehicle service contract will cover that many miles, and known wear and tear issues may scale over time or mileage, for example. Similarly, at module 980, non-powertrain factors are received, such as presence of optional components or known issues with a vehicle class from module 940 which are not related to the powertrain of the vehicle. The non-powertrain factors are similar calculated into the premium, either by adding additional premium cost or multiplying the premium depending on whether the non-powertrain factors add to the cost or scale the cost over time.

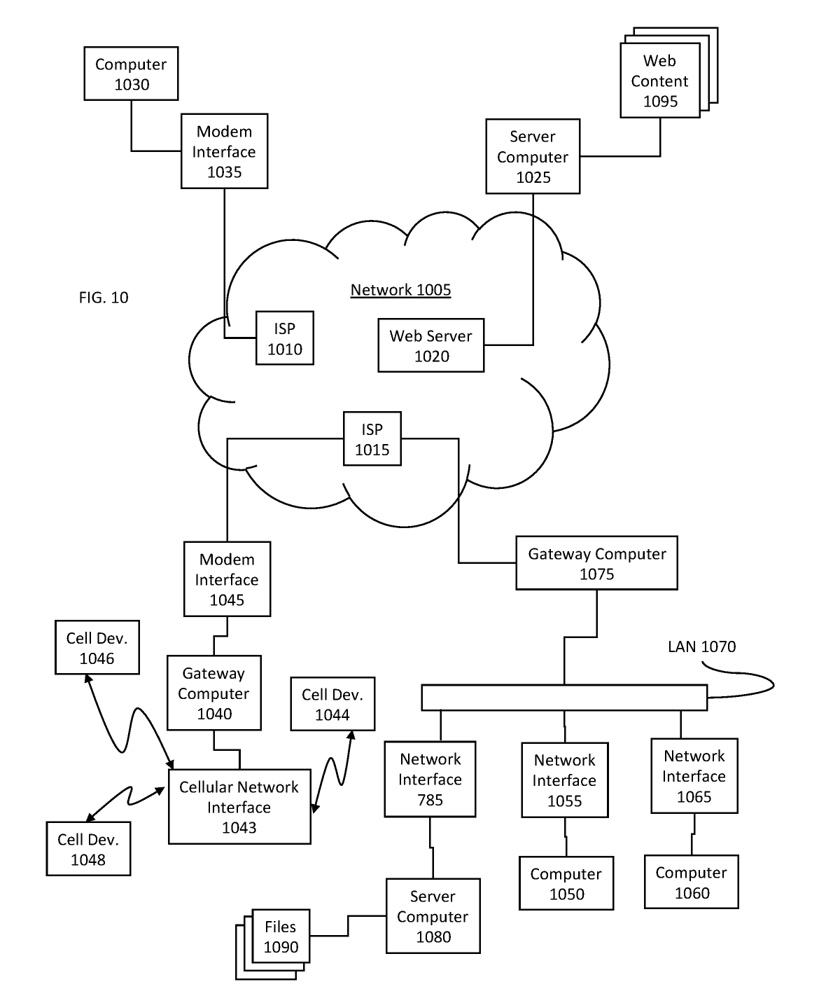

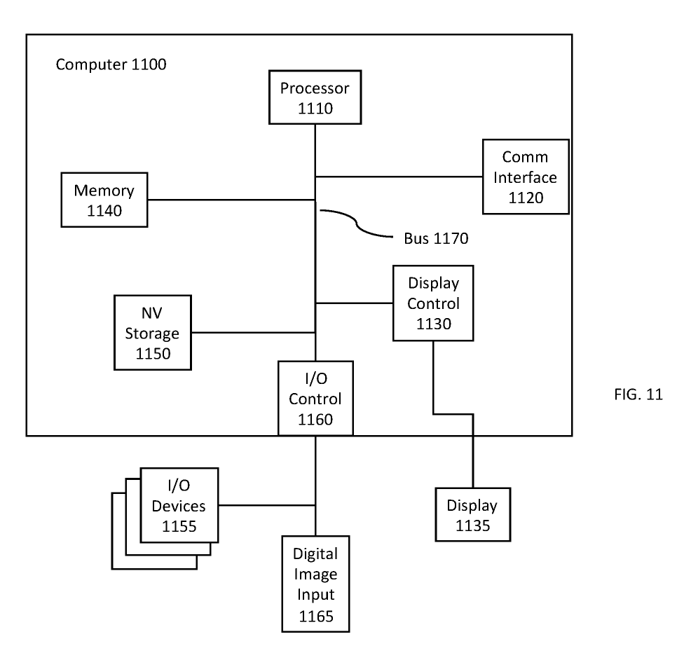

The following description of FIGS. 10-11 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 10 shows several computer systems that are coupled together through a network 1005, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 1005 is typically provided by internet service providers (ISP), such as the ISPs 1010 and 1015. Users on client systems, such as client computer systems 1030, 1050, and 1060 obtain access to the internet through the internet service providers, such as ISPs 1010 and 1015. Access to the internet allows users of the client computer systems to exchange information, receive and send e-mails, and view documents, such as documents which have been prepared in the HTML format. These documents are often provided by web servers, such as web server 1020 which is considered to he “on” the internet. Often these web servers are provided by the ISPs, such as ISP 1010, although a computer system can be set up and connected to the internet without that system also being an ISP.

The web server 1020 is typically at least one computer system which operates as a server computer system and is configured to operate with the protocols of the world wide web and is coupled to the internet. Optionally, the web server 1020 can be part of an ISP which provides access to the internet for client systems. The web server 1020 is shown coupled to the server computer system 1025 which itself is coupled to web content 1095, which can be considered a form of a media database. While two computer systems 1020 and 1025 are shown in FIG. 10, the web server system 1020 and the server computer system 1025 can be one computer system having different software components providing the web server functionality and the server functionality provided by the server computer system 1025 which will be described further below.

Cellular network interface 1043 provides an interface between a cellular network and corresponding cellular devices 1044 1046 and 1048 on one side, and network 1005 on the other side. Thus cellular devices 1044, 1046 and 1048, which may be personal devices including cellular telephones, two-way pagers, personal digital assistants or other similar devices, may connect with network 1005 and exchange information such as email, content, or HTTP-formatted data, for example.

Cellular network interface 1043 is representative of wireless networking in general. In various embodiments such an interface may also be implemented as a wireless interface such as a Bluetooth interface, IEEE 802.11 interface, or some other form of wireless network. Similarly, devices such as devices 1044, 1046 and 1048 may be implemented to communicate via the Bluetooth or 802.11 protocols, for example.

Other Dedicated Wireless Networks may also be Implemented in a Similar Fashion.

Cellular network interface 1043 is coupled to computer 1040, which communicates with network 1005 through modem interface 1045. Computer 1040 may be a personal computer, server computer or the like, and serves as a gateway. Thus, computer 1040 may be similar to client computers 1050 and 1060 or to gateway computer 1075, for example. Software or content may then be uploaded or downloaded through the connection provided by interface 1043, computer 1040 and modem 1045. [0045] Client computer systems 1030, 1050, and 1060 can each, with the appropriate web browsing software, view HTML pages provided by the web server 1020. The ISP 1010 provides internet connectivity to the client computer system 1030 through the modem interface 1035 which can be considered part of the client computer system 1030. The client computer system can be a personal computer system, a network computer, a web tv system, or other such computer system.

Similarly, the ISP 1015 provides internet connectivity for client systems 1050 and 1060, although as shown in FIG. 10, the connections are not the same as for more directly connected computer systems. Client computer systems 1050 and 1060 are part of a LAN coupled through a gateway computer 1075. While FIG. 10 shows the interfaces 1035 and 1045 as generically as a “modem,” each of these interfaces can be an analog modem, isdn modem cable modem, satellite transmission interface (e.g. “direct PC”), or other interfaces for coupling a computer system to other computer systems.

Client computer systems 1050 and 1060 are coupled to a LAN 1070 through network interfaces 1055 and 1065, which can be ethernet network or other network interfaces. The LAN 1070 is also coupled to a gateway computer system 1075 which can provide firewall and other internet related services for the local area network. This gateway computer system 1075 is coupled to the ISP 1015 to provide Internet connectivity to the client computer systems 1050 and 1060. The gateway computer system 1075 can be a conventional server computer system. Also, the web server system 1020 can be a conventional server computer system.

Alternatively, a server computer system 1080 can be directly coupled to the LAN 1070 through a network interface 1085 to provide files 1090 and other services to the clients 1050, 1060, without the need to connect to the internet through the gateway system 1075.

FIG. 11 shows one example of a personal device that can be used as a cellular telephone (1044, 1046 or 1048) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 1100 of FIG. 11 may also be used to implement other devices such as a personal computer, network computer, or other similar systems. The computer system 1100 interfaces to external systems through the communications interface 1120. In a cellular telephone, this interface is typically a radio interface for communication with a cellular network, and may also include some form of cabled interface for use with an immediately available personal computer. In a two-way pager, the communications interface 1120 is typically a radio interface for communication with a data transmission network, but may similarly include a cabled or cradled interface as well. In a personal digital assistant, communications interface 1120 typically includes a cradled or cabled interface, and may also include some form of radio interface such as a Bluetooth or 802.11 interface, or a cellular radio interface for example.

The computer system 1100 includes a processor 1110, Which can be a conventional microprocessor such as an Intel pentium-based microprocessor or other microprocessor, a Texas Instruments digital signal processor, or some combination of the various types or processors. Memory 1140 is coupled to the processor 1110 by a bus 11100. Memory 1140 can he dynamic random access memory (dram) and can also include static ram (sram), or may include FLASH EEPROM, too. The bus 1170 couples the processor 1110 to the memory 1140, also to non-volatile storage 1150, to display controller 1130, and to the input/output (I/O) controller 1160. Note that the display controller 1130 and I/O controller 1160 may be integrated together, and the display may also provide input.

The display controller 1130 controls in the conventional manner a display on a display device 1135 which typically is a liquid crystal display (LCD) or similar flat-panel, small form factor display. The input/output devices 1155 can include a keyboard, or stylus and touch-screen, and may sometimes be extended to include disk drives, printers, a scanner, and other input and output devices, including a mouse or other pointing device. The display controller 1130 and the I/O controller 1160 can be implemented with conventional well known technology. A digital image input device 1165 can be a digital camera which is coupled to an I/O controller 1160 in order to allow images from the digital camera to be input into the device 1100.

The non-volatile storage 1150 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 1100. Rather, a mass storage device on another computer is typically used in conjunction with the more limited storage of the device 1100. Some of this data is often written, by a direct memory access process, into memory 1140 during execution of software in the device 1100. One of skill in the art will immediately recognize that the terms “machine-readable medium” or “computer-readable medium” includes any type of storage device that is accessible by the processor 1110 and also encompasses a carrier wave that encodes a data signal. Alternatively, a physical medium may be used as a machine-readable medium or computer-readable medium.

The device 1100 is one example of many possible devices which have different architectures. For example, devices based on an lintel microprocessor often have multiple buses, one of which can be an input/output (I/O) bus for the peripherals and one that directly connects the processor 1110 and the memory 1140 (often referred to as a memory bus). The buses are connected together through bridge components that perform any necessary translation clue to differing bus protocols.

In addition, the device 1100 is controlled by operating system software which includes a file management system, such as a disk operating system, which is part of the operating system software. One example of an operating system software with its associated file management system software is the family of operating systems known as Windows(r) from Microsoft Corporation of Redmond, Wash., and their associated file management systems. Another example of an operating system software with its associated file management system softs are is the Apple OS(r) operating system and its associated file management system. The file management system is typically stored in the non-volatile storage 1150 and causes the processor 1110 to execute the various acts required by the operating system to input and output data and to store data in memory, including storing files on the non-volatile storage 1150. Other operating systems may be provided by makers of devices, and those operating systems typically will have device-specific features which are not part of similar operating systems on similar devices Similarly, WinCE® or Palm® operating systems may be adapted to specific devices of specific device capabilities.

Device 1100 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others Skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. [0058] The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

It is, therefore, apparent that there is provided, in accordance with the various embodiments disclosed herein, methods, systems and computer readable media for computerized vehicle service contract service offerings having enhanced flexibility.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A method, comprising:
receiving a request for a vehicle service contract, the request including a mileage of a vehicle, a type of the vehicle, a custom requested coverage for the vehicle and a custom requested term of the vehicle service contract;
analyzing specific vehicle details from request for vehicle service contract;
calculating a custom quote for vehicle service contract based on mileage of vehicle, type of vehicle, custom requested coverage and custom requested term of vehicle service contract;
providing the custom quote for vehicle service contract to a consumer;
receiving request to complete vehicle service contract based on custom quote from consumer;
and
issuing vehicle service contract to consumer based on custom quote and request to complete vehicle service contract from consumer.

2. The method of claim 1, further comprising:
receiving a request for coverage of a repair based on the vehicle service contract;
verifying coverage of the repair based on the vehicle service contract;
authorizing coverage of the repair based on the vehicle service contract;
receiving confirmation of completion of the repair based on the vehicle service contract;
and
providing payment at a predetermined rate responsive to confirmation of completion of the repair based on the vehicle service contract.

3. The method of claim 2, wherein:
confirmation of completion of the repair based on the vehicle service contract includes documentation from an entity asserting that the entity completed repairs to the vehicle of the request for vehicle service contract.

4. The method of claim 3, wherein:
calculating the custom quote for the vehicle service contract based on a factor multiplied by mileage of vehicle enumerated in miles, type of vehicle, custom requested coverage and a factor multiplied by custom requested term of vehicle service contract enumerated in calendar days.

5. The method of claim 4, wherein:
calculating the custom quote for the vehicle service contract further based on a factor for any requested powertrain coverage and a factor for any requested non-powertrain coverage.

6. The method of claim 5, wherein:
calculating the custom quote for the vehicle service contract further based on a factor adjusting for present mileage of the vehicle.

7. The method of claim 6, wherein:
calculating the custom quote for the vehicle service contract further based on a factor adjusting for a deductible amount of the vehicle service contract.

8. The method of claim 7, wherein:
calculating the custom quote for the vehicle service contract further based on a factor adjusting for a minimum premium for the vehicle service contract.

9. The method of claim 8, wherein:
calculating the custom quote for the vehicle service contract further based on a factor adjusting for present age of the vehicle enumerated in days.

10. The method of claim 9, wherein:
calculating the custom quote for the vehicle service contract further based on a factor adjusting for a vehicle class of the vehicle.

11. The method of claim 1, wherein:
calculating the custom quote for the vehicle service contract further based on a factor for any requested powertrain coverage and a factor for any requested non-powertrain coverage.

12. The method of claim 11, wherein:
calculating the custom quote for the vehicle service contract further based on a factor adjusting for present mileage of the vehicle enumerated in miles and present age of the vehicle enumerated in days.

13. The method of claim 12, wherein:
calculating the custom quote for the vehicle service contract further based on a factor adjusting for a vehicle class of the vehicle.

14. The method of claim 13, wherein:
calculating the custom quote for the vehicle service contract further based on a factor adjusting for a deductible amount of the vehicle service contract and a minimum premium for the vehicle service contract.

15. A method, comprising:
receiving a request for a vehicle service contract, the request including a mileage of a vehicle, a type of the vehicle, a custom requested coverage for the vehicle and a custom requested term of the vehicle service contract;
analyzing specific vehicle details from request for vehicle service contract;
calculating a custom quote for vehicle service contract based on mileage of vehicle enumerated in miles, type of vehicle, custom requested coverage, custom requested term of vehicle service contract enumerated in days, a factor for any requested powertrain coverage, a factor for any requested non-powertrain coverage, a factor adjusting for present mileage of the vehicle enumerated in miles, a factor adjusting for present age of the vehicle enumerated in days, a factor adjusting for a vehicle class of the vehicle, a factor adjusting for a deductible amount of the vehicle service contract and a minimum premium for the vehicle service contract;
providing the custom quote for vehicle service contract to a consumer;
receiving request to complete vehicle service contract based on custom quote from consumer;
issuing vehicle service contract to consumer based on custom quote and request to complete vehicle service contract from consumer;
receiving a request for coverage of a repair based on the vehicle service contract;
verifying coverage of the repair based on the vehicle service contract;
authorizing coverage of the repair based on the vehicle service contract;
receiving confirmation of completion of the repair based on the vehicle service contract including documentation from an entity asserting that the entity completed repairs to the vehicle of the request for vehicle service contract;
and
providing payment at a predetermined rate responsive to confirmation of completion of the repair based on the vehicle service contract.

16. A method, comprising:
receiving a request for a vehicle service contract, the request including a mileage of a vehicle, a type of the vehicle, a custom requested coverage for the vehicle and a custom requested term of the vehicle service contract;
analyzing specific vehicle details from request for vehicle service contract;
calculating a custom quote for vehicle service contract based on covered mileage of vehicle enumerated in miles, type of vehicle, custom requested coverage, custom requested term of vehicle service contract enumerated in days, a factor for any requested powertrain coverage, a factor for any requested non-powertrain coverage, a factor adjusting for present mileage of the vehicle enumerated in miles, and a factor adjusting for present age of the vehicle enumerated in days;
providing the custom quote for vehicle service contract to a consumer;
receiving request to complete vehicle service contract based on custom quote from consumer;
issuing vehicle service contract to consumer based on custom quote and request to complete vehicle service contract from consumer;
receiving a request for coverage of a repair based on the vehicle service contract;
verifying coverage of the repair based on the vehicle service contract;
authorizing coverage of the repair based on the vehicle service contract;
receiving confirmation of completion of the repair based on the vehicle service contract including documentation from an entity asserting that the entity completed repairs to the vehicle of the request for vehicle service contract;
and
providing payment at a predetermined rate responsive to confirmation of completion of the repair based on the vehicle service contract.

17. The method of claim 16, wherein:
calculating a custom quote for vehicle service contract further based on a factor adjusting for a vehicle class of the vehicle, a factor adjusting for a deductible amount of the vehicle service contract and a minimum premium for the vehicle service contract.
